(19) United States
(12) Patent Application Publication
(10) Pub. No.: US 2005/0252345 A1
(43) Pub. Date: Nov. 17, 2005

(54) Non-recoil striking tool and process for making same

(76) Inventors: Joseph Allen Carmien, Palm Desert, CA (US); Phyllis S. Carmien, Palm Desert, CA (US)

Correspondence Address: KELLY LOWRY & KELLEY, LLP, 6320 CANOGA AVENUE, SUITE 1650, WOODLAND HILLS, CA, 91367, US

(21) Appl. No.: 10/843,951

(22) Filed: May 11, 2004

(51) Int. Cl. B25D 1/00

(52) U.S. Cl. 81/22

(57) ABSTRACT

A non-recoil striking tool and related production method are provided. The striking tool includes a metal tool head having an internal cavity, a handle-receiving socket, a port defining a passageway between the internal cavity and the handle-receiving socket, and an impact member. A flowable filler material of relatively high mass partially fills the internal cavity. A handle has an end fixed within the handle-receiving socket to prevent escape of the flowable filler material from the internal cavity and the handle extends away from the tool head. The method for making the non-recoil striking tool includes providing the metal tool head defining an open internal cavity, an impact member, and the handle-receiving socket. The internal cavity is partially filled with the flowable filler material of relatively high mass through the handle-receiving socket. The end of the handle is then fixed within the handle-receiving socket such that the rest of the handle extends away from the metal tool head.

### BACKGROUND OF THE INVENTION

This invention relates generally to improvements in impact type hand tools such as hammers and mallets and the like, and to related processes for manufacturing such hand tools. More particularly, this invention relates to an improved striking tool having a tool head containing a flowable filler material to provide the striking tool with non-recoil characteristics during normal use.

Hammers of the type have a tool head defining one or more metal impact members are well known in the art, for use in striking a target or work surface. In this regard, such hammers are available in a broad range of tool head sizes, shapes and weights in accordance with the particular task or tasks to be performed, such as driving nails or breaking concrete. Since marking or other damage to the target surface is frequently not an issue, the tool head is commonly constructed from a tough grade and preferably hardened steel to provide durable impact members for extended service life. One example of such hammers comprises a conventional carpenter's framing hammer having a hardened steel tool head with a central aperture or eyehole for assembly with a tool handle, wherein the tool head defines an impact member and a nail removal claw at opposite ends thereof. The tool head of such framing hammer is used for a variety of tasks, including driving nails, removal of nails, and other prying and wedging functions.

One problem encountered with traditional hammers of the type having a metal tool head relates to hammer rebound or recoil from a target surface after striking an impact blow. More specifically, when the hammer is swung by a worker to strike a target surface, most of the kinetic energy is transmitted from the impact member of the hammer to the target surface at the moment of impact. However, a portion of this kinetic energy is not transmitted to the target surface, but instead causes the hard-faced tool head to rebound or recoil from the target surface. This rebound effect thus prevents complete or substantially complete energy transfer to the target surface, thereby typically requiring an increased number of impact blows to perform a given task, e.g., driving a nail. Alternately, this rebound effect requires the worker to swing the hammer with an increased force, or to use a hammer with a heavier tool head, in order to complete a task with a reduced number of impact blows. Moreover, the worker must maintain a grasp of the hammer following an impact blow with sufficient strength to resist rebound forces in order to prevent loss of control. All of these factors undesirably increase the degree of strength and skill required for proper and safe hammer usage.

Nonrecoil or so-called deadblow hammers have been developed in an attempt to reduce or eliminate rebound of the tool head from a target surface following an impact blow. Such nonrecoil or deadblow hammers typically have a tool head defined by a hollow core canister filled partially with a relatively high mass and flowable filler material such as steel shot pellets, steel pins, or the like. In many designs, the hollow canister is protectively encased in whole or in part within a molded jacket or cladding constructed from a selected tough and durable thermoplastic material such as nylon. In use, when the tool head is impacted with a target surface, the filler material shifts and slides about within the hollow canister to absorb and dissipate the impact force in a manner which effectively counteracts any resultant rebound force. As a result, a greater proportion of the kinetic energy is transmitted from the tool head to the target surface in the course of each blow, to permit performance of a given task in a reduced number of blows, or alternately to permit use of a hammer having a lighter tool head. In addition, less strength and skill are required to control the hammer following each blow. For examples of such nonrecoil impact tools, see U.S. Pat. Nos. 5,262,113 and 5,375,486. However, nonrecoil hammers have generally been limited to mallets and the like having relatively soft impact faces designed to avoid marking or damage to the target surface, or alternately to include metal-faced caps designed to mount upon a tool head formed primarily from relatively soft or nonmetallic materials. Such hammers have generally been ill-suited for use, for example, in a typical carpentry or framing environment wherein a hardened steel tool head is desired.

Accordingly, there is a need for an improved hammer or other striking tool of the type having a rigid tool head of hardened steel or the like to define at least one hard-faced impact member. There is a further need for a striking tool where the tool head contains a flowable filler material of relatively high mass to provide the hammer with substantial nonrecoil characteristics following an impact blow to a target surface. The present invention satisfies these needs and provides other related advantages.

### SUMMARY OF THE INVENTION

In accordance with an embodiment of the invention, an improved non-recoil striking tool and related production method are provided.

The non-recoil striking tool includes a metal tool head including an internal cavity, a handle-receiving socket, a port defining a passageway between the internal cavity and the handle-receiving socket, and an impact member. A flowable filler material of relatively high mass partially fills the internal cavity. This filler material comes in various forms including metallic pellets.

The striking tool also includes a handle having an end fixed within the handle-receiving socket. The placement of the handle within the socket helps to prevent escape of the flowable filler material from the internal cavity. The portion of the handle (i.e., the portion of the handle not fixed within the socket) extends away from the tool head.

An additional aid in preventing the flowable filler material from escaping through the passageway is a plug disposed therein. The end of the handle fixed within the handle-receiving socket is disposed adjacent to the plug.

The metal tool head comprises a hammer head. The impact member of the tool head includes first and second work members located on opposite sides of the internal cavity. The first work member includes a front impact face and the second work member includes a nail removal claw.

A grip is mounted over a portion of the handle extending from the tool head in order to provide the user with a better hold on the striking tool. The grip helps to reduce slippage of the tool in the user's grasp when the tool is in use.

The method for making the non-recoil striking tool includes providing the metal tool head defining an open internal cavity, the impact member, and the handle-receiving socket.

The internal cavity is then partially filled with the flowable filler material of relatively high mass through the handle-receiving socket. The tool head includes a port defining a passageway between the internal cavity and the handle-receiving socket.

The handle-receiving socket is sealed to prevent escape of the flowable filler material from the internal cavity. As stated above, this filler material comes in various forms including metallic pellets which can escape from the tool head through the passageway if the passageway is not sealed. A plug is inserted into the port when the desired amount of filler material has been added to the cavity. An end of a handle is then placed adjacent to the plug. The handle is fixed within the handle-receiving socket such that the handle extends away from the metal tool head. A grip is placed over a portion of the handle extending from the tool head.

The impact member includes first and second work members on opposite sides of the internal cavity. The first work member comprises a front impact face and the second work member comprises a nail removal claw.

In use, upon swinging of the tool to strike one of the took work members such as the front impact member against a target surface, the flowable filler material within the canister shifts in the direction of the impact blow to absorb and dissipate shock forces in a manner which focuses the impact energy upon the target surface while reducing or eliminating any significant rebound. In this regard, the canister containing the filler material is tightly constrained within its opposite end faces seated against the inboard end walls of the tool head lining the socket, resulting in efficient energy transfer between the canister and the tool head.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a side elevational view of the improved nonrecoil hammer constructed according to the present invention;

FIG. 2 is an exploded and fragmented side elevational view illustrating assembly of the tool handle and plug with the tool head;

FIG. 3 is an exploded and fragmented side elevational view illustrating assembly of the tool handle, plug, and flowable material with the tool head; and

FIG. 4 is a vertical sectional view illustrating the tool handle and plug in assembled relation with the tool head.

### DETAILED DESCRIPTION OF THE PREFERRED EMBODIMENT

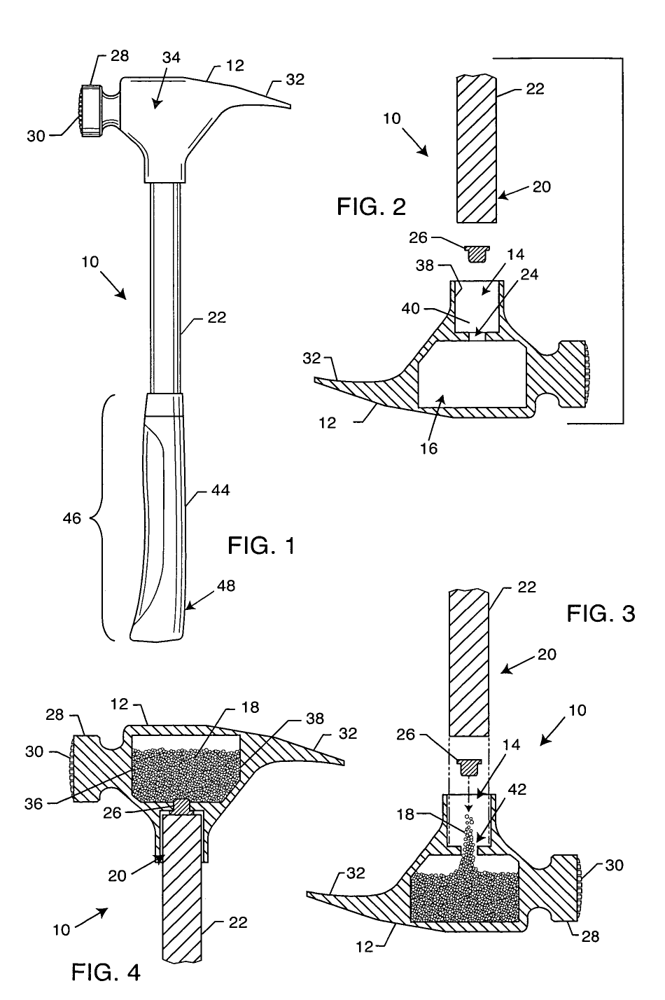

As shown in the exemplary drawings, an improved nonrecoil striking tool (e.g., a non-recoil or deadblow hammer), referred to generally in FIGS. 1-4 by the reference numeral 10, includes a tool head 12 of the type formed from a hard and preferably metal material such as hardened steel (e.g., a steel hammer head).

This tool head 12 has an open socket 14 formed therein that leads to an internal cavity 16 within the tool head 12. The internal cavity 16 receives and contains a relatively high mass flowable filler material 18 of various forms including, but not limited to metallic shot pellets (e.g., steel, copper, or any metal of relatively high mass), pins, slugs or the like, to provide the striking tool 10 with substantial non-recoil or deadblow characteristics during normal use. One end 20 of a handle 22 is received in the open socket 14 and coupled to the tool head 12. The placement of the handle end 20 within the socket 14 helps to prevent escape of the flowable filler material 18 from the internal cavity 16. The remaining portion of the handle 22 (i.e., the portion of the handle not fixed within the socket) extends away from the tool head.

A port or aperture 24 for accessing the internal cavity 16 is located between the internal cavity 16 and the handle-receiving socket 14. The port 24 defines a passageway 25 between the internal cavity 16 and the handle-receiving socket 14. Once the internal cavity 16 is at least partially filled with the filler material 18, a device for closing 26 the port 24 to the internal cavity 16 in order to contain the flowable filler material 18 therein (i.e., prevent the flowable filler material 18 from escaping the internal cavity 16 through the passageway 25), such as a stopper or plug, may be placed within the port 24 to block the passageway 25 prior to the handle 22 being inserted within the socket 14. The plug 26 may be made from a variety of materials including, without limitation, plastic, rubber, wood, metal or the like. The end 20 of the handle 22 fixed within the handle-receiving socket 14 is disposed adjacent to the plug 26.

The improved striking tool 10 of the present invention is designed for use in a broad range of manually operated impact tool tasks wherein a hard metal tool head 12 is preferred or required, and further wherein potential marking or damage to a target surface in response to impact blows is not a significant concern. In this regard, the illustrative drawings show the tool head 12 in a geometry to include front and rear work members in the form of a front impact member 28 defining a hard-surfaced impact face 30, and a rear cleft-shaped nail removal claw 32, in conformance with the construction of a conventional so-called carpenter's framing hammer. Such framing hammer desirably includes the front impact member 28 and the rear claw 32 of relatively hard steel for performing a range of tasks such as nail driving and nail pulling. In addition, in a hammer of this type, it is desirable for the remainder of the tool head 12 to be constructed from a rigid and hard material such as a hardened steel body formed integrally with the front and rear work members 28, 32 so that the hammer can also be used for a variety of other tasks, including but not limited to wedging, prying, etc. The present invention provides the improved striking tool 10 with all of these desirable characteristics, but in addition provides the striking tool 10 with beneficial non-recoil or deadblow characteristics for improved delivery of the energy of an impact blow to a target surface with reduced hammer rebound and resultant reduced worker fatigue.

The tool head 12 includes a central body 34 having the front impact member 28 and the rear nail removal claw 32 formed at opposite ends thereof. In the preferred construction, the tool head 12 is formed as a unitary metal structure, preferably from a hardened steel. The central body 34 includes the socket 14 formed therein and the internal cavity 16 with the port 24 located therebetween. This socket 14 comprises a cavity of sized and shaped to receive a portion of the length of one end 20 of the handle 22 and lined by upstanding front and rear end walls 36 and 38, a pair of upstanding side walls 40, and by a top wall 42 in which the port 24 is located. The internal cavity 24 is disposed generally in axial alignment with and thus defines inboard end walls for the front and rear work members 28, 32 of the striking tool 10.

After placement of the filler material 18 into the internal cavity 16 through the port 24, the port 24 is closed by inserting the plug 26 into the port 24. Insertion of the plug 26 also seals the internal cavity 16. The end 22 of the tool handle 20 is then extended into the socket 14 with the remainder of the handle 20 providing convenient manual grasping during use of the striking tool 10. The end 20 of the handle 22 abuts against the portion of the plug 26 within the socket 14. A resilient grip 44 may be mounted over a portion 46 of the handle 22 extending from the tool head 12, generally along a length of the handle 22 towards an end 48 of the tool handle 22 opposite the metal tool head 12.

An adhesive may be placed along the walls 36-42 to aid in retaining the handle 22 within the handle-receiving socket 14. The adhesive and handle end 20 provide a sealing effect for holding the filler material 18 within the internal cavity 16 whether or not the plug 26 is positioned within the port 24.

In accordance with a preferred method of producing the improved striking tool 10 of the present invention, the metal tool head 12 defining the open internal cavity 16, the impact member 28 and the handle-receiving socket 14 is provided to mate with the handle 22. However, the flowable filler material 18 is placed into the hollow internal cavity 16 prior to attachment of the tool handle 22 to the metal tool head 12. In order to at least partially fill the internal cavity 16 with the flowable filler material 18, the tool head 12 is inverted with the handle-receiving socket 14 facing upwards such that a user may pour the filler material 18 downwards into the socket 14 where the filler material 18 flows through the port 24 and passageway 25 into the internal cavity 16.

The cavity 16 is closed by means of the plug 26 being inserted into the port 24 between the internal cavity 16 and the socket 14. The plug 26 provides a snug fit with the port 24 in order to seal the filler material 18 within the internal cavity 16.

The tool handle 22 is then assembled with the tool head 12 by positioning and sliding the handle 22 downwardly through the open socket 14 until the end 20 of the handle 22 is at least partially received within the socket 14 with the remainder of the handle 22 extending away from the metal tool head 12. In the socket 14, the end 20 of the handle 22 is adjacent to the plug 26. Prior to the tool handle 22 being inserted into the socket 14, a layer of adhesive may be coated on the walls 36-42 of the socket 14 in order to couple the handle 22 to the tool head 12. The portion of the plug 26 within the socket 14 may also be also coated with the adhesive to further seal the port 24 and adhere the plug 26 to the handle 22. In the alternative, the plug 26 may be integrally formed with the handle 22 as either a single-piece construction or as two parts joined together. The resilient hand grip 44 can then be mounted over the portion 46 of the handle 22 extending from the tool head 12.

In use, the striking tool 10 can be employed by a worker to perform any of the traditional impact, prying, etc., functions normally associated with a conventional carpenter's framing hammer. Upon striking an impact blow by swinging the front impact member 28 against a target surface, such as the head of a nail, the flowable filler material 18 within the tool head 12 shifts in the direction of the blow at the moment of impact to focus the impact energy upon the target surface. As a result, little energy is available for causing any significant recoil or rebound of the hammer from the target surface following the impact blow. Accordingly, by applying an increased proportion of the impact energy to the target surface for each blow, the improved striking tool (e.g., a hammer) of the present invention is beneficially capable of performing tasks with a reduced effort, either in terms of the number of blows or in terms of the force of each blow, in comparison with a conventional solid steel tool head hammer of comparable weight. Alternatively, the improved striking tool of the present invention permits a striking tool of lighter weight to be used. Moreover, the non-recoil characteristics of the striking tool 10 result in further reductions in worker effort and fatigue.

The above-described embodiment of the present invention is illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

1. A method for making a non-recoil striking tool, comprising the steps of:
providing a metal tool head defining an open internal cavity, an impact member, and a handle-receiving socket;
partially filling the internal cavity with a flowable filler material of relatively high mass through the handle-receiving socket; and
fixing an end of a handle within the handle-receiving socket such that the handle extends away from the metal tool head.

2. The method of claim 1, wherein the tool head includes a port defining a passageway between the internal cavity and the handle-receiving socket.

3. The method of claim 2, including the step of inserting a plug into the port prior to the handle fixing step.

4. The method of claim 3, including the step of placing the end of the handle adjacent to the plug prior to the fixing step.

5. The method of claim 1, wherein the fixing step includes the step of sealing the handle-receiving socket to prevent escape of the flowable filler material from the internal cavity.

6. The method of claim 1, wherein the impact member includes first and second work members on opposite sides of the internal cavity.

7. The method of claim 6, wherein the first work member comprises a front impact face and the second work member comprises a nail removal claw.

8. The method of claim 1, wherein the filler material comprises metallic pellets.

9. The method of claim 1, comprising the step of placing a grip over a portion of the handle extending from the tool head.

10. A method for making a non-recoil striking tool, comprising the steps of:
providing a metal tool head defining an open internal cavity, an impact member, a handle-receiving socket, and a port defining a passageway between the internal cavity and the handle-receiving socket;
partially filling the internal cavity with a flowable filler material comprising metallic pellets of relatively high mass through the handle-receiving socket;
inserting a plug into the port;
fixing an end of a handle within the handle-receiving socket such that the handle extends away from the metal tool head; and
placing a grip over a portion of the handle extending from the tool head.

11. The method of claim 10, including the step of placing the end of the handle adjacent to the plug prior to the fixing step.

12. The method of claim 10, wherein the fixing step includes the step of sealing the handle-receiving socket to prevent escape of the flowable filler material from the internal cavity, and the at least one impact member includes a front impact face and a nail removal claw on opposite sides of the internal cavity.

13. A non-recoil striking tool, comprising:
a metal tool head including an internal cavity, a handle-receiving socket, a port defining a passageway between the internal cavity and the handle-receiving socket, and an impact member;
a flowable filler material of relatively high mass partially filling the internal cavity; and
a handle having an end fixed within the handle-receiving socket to prevent escape of the flowable filler material from the internal cavity and extending away from the tool head.

14. The non-recoil tool of claim 13, including a plug disposed within the passageway to prevent escape of the flowable filler material therethrough.

15. The non-recoil tool of claim 14, wherein the end of the handle fixed within the handle-receiving socket is disposed adjacent to the plug.

16. The non-recoil tool of claim 13, wherein the impact member includes first and second work members located on opposite sides of the internal cavity.

17. The non-recoil tool of claim 16, wherein the first work member comprises a front impact face and the second work member comprises a nail removal claw.

18. The non-recoil tool of claim 13, wherein the metal tool head comprises a hammer head.

19. The non-recoil tool of claim 13, wherein the filler material comprises metallic pellets.

20. The non-recoil tool of claim 13, including a grip over a portion of the handle extending from the tool head.

21. A non-recoil striking tool, comprising:
a metal tool head including an internal cavity, a handle-receiving socket, a port defining a passageway between the internal cavity and the handle-receiving socket, and an impact member;
a flowable filler material comprising metallic pellets of relatively high mass partially filling the internal cavity;
a plug disposed within the passageway to prevent escape of the flowable filler material therethrough;
a handle having an end fixed within the handle-receiving socket, disposed adjacent to the plug, and extending away from the tool head; and
a grip over a portion of the handle extending from the tool head.

22. The non-recoil tool of claim 21, wherein the impact member includes a front impact face and a nail removal claw located on opposite sides of the internal cavity.

23. The non-recoil tool of claim 21, wherein the metal tool head comprises a hammer head.
